(19) United States
(12) Patent Application Publication
(10) Pub. No.: US 2022/0329096 A1
(43) Pub. Date: Oct. 13, 2022

(54) System and method for wirelessly charging earphones

(71) Applicant: Zgmicro Wuxi Corporation, Wuxi (CN)

(72) Inventors: Zhao WANG, Wuxi (CN); Xiaodong YANG, Wuxi (CN)

(21) Appl. No.: 17/715,017

(22) Filed: Apr. 6, 2022

(30) Foreign Application Priority Data
Apr. 7, 2021 (CN) 202110373605.5

(51) Int. Cl. H02J 7/00; H02J 50/80; H02M 3/158; H04R 1/10

(52) U.S. Cl. CPC H02J 7/00712; H02J 50/80; H02M 3/158; H04R 1/1041; H04R 1/1025; H02J 2207/20; H04R 2420/07

(57) ABSTRACT

Techniques for wirelessly charging a portable device are described. Charging circuits are designed based on energy efficiency that a charging voltage increases when the voltage of a battery being charged increases. In the case of charging a wireless earphone, the voltage output from a charging case changes in real time in accordance with the voltage on the battery in the earphone so as to reduce the energy consumption and improve the energy efficiency.

### BACKGROUND OF THE INVENTION

### Field of the Invention

The present invention relates to the field of earphones, in particular to charging circuit, system and method for a wireless earphone.

### Description of the Related Art

Compared with wired earphones, wireless earphones have an advantage of being convenient to carry around so they are getting more and more popular. In the prior art, a charging case outputs a predefined or fixed voltage, such as 5V. A wireless earphone includes a charging management unit configured to charge a battery in an earphone (earphone battery). The voltage from the charging case is converted by the charging management unit to perform constant current charging or constant voltage charging of the earphone battery. A voltage of the earphone battery, between positive and negative terminals of the earphone battery, will gradually increase over charging time until it reaches a full voltage value. During a charging process, when the voltage of the earphone battery is, for example, 3V, an energy efficiency is 3/5=60% which is considered very low.

Therefore, there is a need for an improved solution to solve at least the above-mentioned problem.

### SUMMARY OF THE INVENTION

In general, the present invention is related to a charging circuit, a charging system and a charging method for a portable device, such as a wireless earphone. The description of the present invention is based on a wireless earphone, those skilled in the art may appreciate that that disclosure herein is equally applicable to other devices that need to be charged via a charging station, where the charging station may include a battery that needs to be fully charged first.

A charging circuit in a case and a wireless earphone circuit are provided according to one embodiment of the present application. A voltage output by the charging case circuit can change with a voltage required by the wireless earphone circuit in real time, thereby reducing energy consumption, and improving energy efficiency.

One of objectives of the present invention is to provide a charging technique that the charging voltage increases when the voltage of a battery being charged increases. The voltage output by a charging case for an earphone changes with the voltage required by the earphone in real time so as to reduce the energy consumption and improve the energy efficiency.

According to one embodiment, the present invention is charging circuit provided to wirelessly charge an earphone, the circuit comprising: a first battery, a first charging management unit performing charging management to the first battery, a first communication unit obtaining data including information representing a voltage of an earphone battery being charged in the earphone via a wireless earphone circuit, wherein the wireless earphone circuit is housed in the earphone. The charging unit further comprises a voltage conversion unit converting a voltage of the first battery into an output voltage according to the data and outputting the output voltage through a voltage output terminal, wherein the output voltage is positively related to the voltage of the earphone battery, and is greater than or equal to a voltage required by the wireless earphone circuit, and the output voltage increases in real time as the voltage required by the wireless earphone circuit increases, the output voltage is a sum of the voltage of the earphone battery being charged and a predetermined voltage value.

According to another embodiment, the present invention is a charging method for wirelessly charging an earphone, the charging method comprises obtaining data wirelessly from an earphone when the earphone is in a charging case, the data including information representing a voltage of a battery in the earphone being charged via a wireless earphone circuit housed in the earphone; and converting a voltage of a battery in the charging case into an output voltage according to the information, and then outputting the output voltage through a voltage output terminal of the charging case, wherein the output voltage increases when the voltage of the battery being charged increases, the output voltage is greater than or equal to a voltage required by the wireless earphone circuit, and the voltage required by the wireless earphone circuit is a sum of the voltage of the battery being charged and a predetermined voltage value.

One of the objectives, advantages and benefits in the present invention is a mechanism that can adjust the output voltage to charge a battery in an earphone according to the voltage required by the wireless earphone circuit in the earphone.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic structural diagram of a charging system in a wireless earphone in the prior art;

FIG. 2 is a schematic structural diagram of a charging case circuit according to one embodiment of the present application;

FIG. 3A is a schematic circuit diagram of a voltage conversion unit of the charging case circuit shown in FIG. 2 according to one embodiment of the present application;

FIG. 3B is a schematic circuit diagram of the voltage conversion unit of the charging case circuit shown in FIG. 2 according to another embodiment of the present application;

FIG. 4 is a waveform diagram of a current of an inductor in the voltage conversion unit shown in FIG. 3B;

FIG. 5 is a schematic structural diagram of a circuit in a wireless earphone (wireless earphone circuit) according to one embodiment of the present application;

FIG. 6 is a schematic structural diagram of a charging system according to one embodiment of the present application; and

FIG. 7 is a flowchart of a charging method according to one embodiment of the present application.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

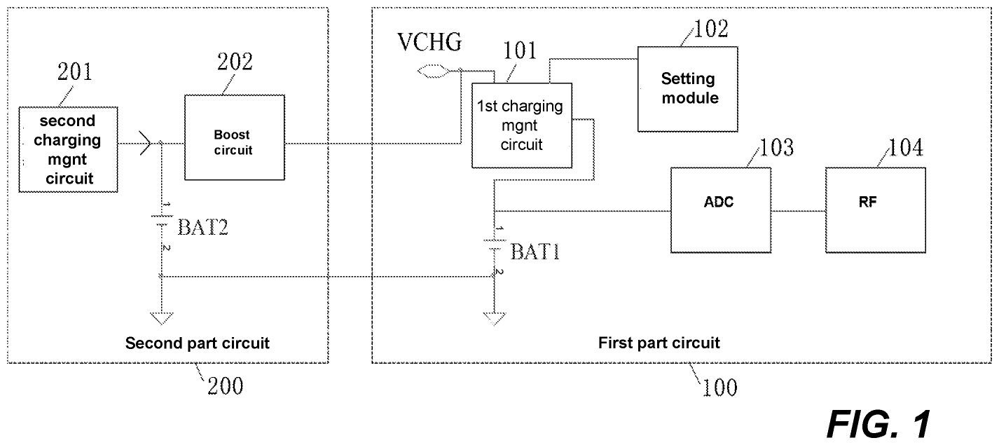

FIG. 1 is a schematic structural diagram of a charging system of a wireless earphone in the prior art. The wireless earphone may be a true wireless stereo (TWS) earphone. As shown in FIG. 1, the charging system comprises a first part circuit 100 located in the TWS earphone and a second part circuit 200 located in a charging case. The first partial circuit 100 comprises a first battery BAT1, a first charge management circuit 101, a setting module 102, an analog-to-digital (ADC) converter 103 and a radio frequency (RF) circuit 104. The first charging management circuit 101 is configured to charge the first battery BAT1. The setting module 102 is configured to set a charging current of the first charging management circuit 101. The ADC 103 is configured to measure a power of the first battery BAT1. The RF 104 is configured to realize wireless communication, and receive audio signals.

The second part circuit 200 comprises a second battery BAT2, a second charging management circuit 201 and a boost circuit 202. The second charging management circuit 201 is configured to charge the second battery BAT2. The boost circuit 202 is configured to boost a voltage of the second battery BAT2 to a predefined or fixed voltage and output it to a charging terminal VCHG. For example, the fixed voltage is 5V. Hence the voltage of VCHG is 5V. The first charging management circuit 101 in the earphone charges the first battery BAT1 up to the fixed voltage. In FIG. 1, the charging case outputs the fixed voltage and the earphone performs charging management to the second battery through the charging management unit 101. In operation, the fixed voltage output by the charging case 200 is converted to perform constant current charging or constant voltage charging to the second battery BAT2. When the voltage of the first battery is 3V, the energy efficiency is 3/5=60%. There is 2V loss in the charging management circuit 101, thereby resulting in low energy efficiency during charging.

In view of the deficiency, a charging case, a charging case circuit, a wireless earphone, a wireless earphone circuit, and a charging method are provided according to one embodiment of the present application. A voltage output by the charging case circuit can change with a voltage required by the earphone in real time, thereby reducing energy consumption, and improving energy efficiency.

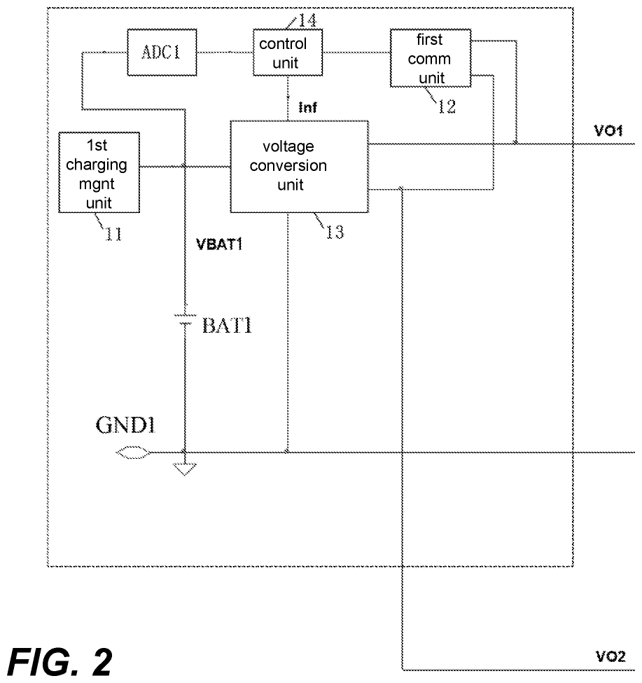

FIG. 2 is a schematic structural diagram of a charging case circuit according to one embodiment of the present application. The charging case circuit comprises a first battery BAT1, a first charging management unit 11, a first communication unit 12 and a voltage conversion unit 13. The first charge management unit 11 is configured for performing charging management to the first battery BAT1. The first communication unit 12 is configured for obtaining first data from the wireless earphone or a circuit therein. The first data includes at least first information representing a voltage of a battery to be charged in the wireless earphone. The voltage of the battery in the wireless earphone, or the voltage required by a circuit in the earphone (wireless earphone circuit) can be obtained according to the first data.

The voltage conversion unit 13 is configured to convert a voltage of the first battery BAT1 into an output voltage according to the first data, and then output the voltage through a voltage output terminal. The output voltage is positively related to the voltage of the battery to be charged. Specifically, the output voltage increases as the voltage of the battery to be charged increases.

The output voltage may be greater than or equal to the voltage required by the earphone. The voltage required by the earphone is a sum of the voltage of the battery to be charged and a predetermined voltage value. The predetermined voltage value can be a preset value or a voltage value that is consumed by a pre-specified circuit unit. The predetermined voltage value can be determined according to the voltage consumed by other components or circuits in the earphone except for the battery to be charged during charging. In one embodiment, the wireless earphone circuit may determine the predetermined voltage value and send it to the charging case circuit. In another embodiment, the predetermined voltage value may be preset in the charging circuit in the case (charging case circuit).

In one embodiment, the first information includes the voltage of the battery to be charged. In another embodiment, the first information includes the voltage required by the wireless earphone circuit. In still another embodiment, the first information includes the voltage of the battery to be charged and the predetermined voltage value.

In one embodiment, the predetermined voltage value can be set as a voltage difference between an input terminal and an output terminal of the charging management unit of the wireless earphone circuit when the charging management unit is working. For example, when it is known based on the first information that the voltage of the battery to be charged is 3.6V, and the voltage difference between the input terminal and the output terminal of the charging management unit of the wireless earphone circuit is 0.1V, the voltage required by the wireless earphone circuit may be 3.6V+0.1V=3.7V. At this time, the charging case circuit can output 3.7V as the output voltage, the energy efficiency is 3.6/3.7=97.3%. For another example, provided that the voltage of the battery to be charged is 3.9V, the voltage difference between the input terminal and the output terminal of the charging management unit of the wireless earphone circuit is 0.1V, the voltage required by the wireless earphone circuit is 3.9V+0.1V=4V. At this time, the charging case circuit can output 4V as the output voltage, and the energy efficiency is 3.9/4=97.5%. Therefore, when the charging case circuit of the present application is used to charge the battery in an earphone, the energy efficiency is relatively high. It can be understood that, in some embodiments, the predetermined voltage value can also be set to a predetermined value slightly higher than the voltage difference between the input terminal and the output terminal of the charging management unit of the earphone, such as 0.3V and so on.

The voltage conversion unit 13 may determine a reference voltage used for buck/boost regulation based on the voltage required by the earphone and obtained from the first information. As a result, the output of voltage conversion unit 13 can be stabilized at a target voltage relative to the reference voltage. In one embodiment, the reference voltage may be equal to or proportional to the target voltage.

In one embodiment, the voltage conversion unit 13 obtains the first information from the first communication unit 12, and then obtains the voltage required by the wireless earphone circuit according to the first information.

In one embodiment, the first communication unit 12 communicates with the earphone to obtain a voltage of the battery to be charged therein, and the voltage conversion unit 13 converts the voltage of the first battery BAT1 into the output voltage according to the voltage of the earphone battery, and then output the output voltage through the voltage output terminal. The output voltage is positively related to the voltage of the earphone battery, and is greater than or equal to the voltage required by the wireless earphone circuit. The voltage required by the wireless earphone circuit is a sum of the voltage of the battery to be charged and a predetermined voltage value. That is, the output voltage output by the charging case circuit can change with the voltage required by the wireless earphone circuit in real time, thereby reducing the energy consumption of the charging circuit, and improving the energy efficiency.

In one embodiment, the first data may further comprise at least a software program loaded in the charging case and a temperature of the battery to be charged. The software program may be an upgrade program of the charging case. For example, in a specific application scenario, a terminal device such as a mobile phone can send the upgrade program of the charging case to the wireless earphone first through a wireless communication such as Bluetooth. When the wireless earphone is charged in the charging case, the wireless earphone sends the upgrade program of the charging case to the charging case. Depending on specific implementation, the first data may also comprise other information that are needed to the charging case.

In addition, the charging case circuit can send first data to the wireless earphone circuit. The second data comprises at least one of a state of a cover of the charging case, a temperature and a remaining power of the first battery BAT1, and a software program to be loaded into the wireless earphone circuit. Depending on specific implementation, the information comprised in the second data may be set depending implementation.

In one embodiment, the first communication unit is further configured to send the second data to the wireless earphone circuit. The first communication unit 12 communicates with the wireless earphone circuit wirelessly. The first communication unit 12 may be is implemented as a wireless radio frequency unit.

In another embodiment, the first communication unit 12 performs wired communication with the wireless earphone circuit through the voltage output terminal. The charging case circuit further comprises a control unit 14. The control unit 14 is configured for controlling the first communication unit 12 and the voltage conversion unit 13 to time-division multiplex the voltage output terminal during the charging process. When the first communication unit 12 communicates with the wireless earphone circuit through the voltage output terminal, the voltage conversion unit 13 stops outputting the output voltage through the voltage output terminal. At this time, the first communication unit 12 can send the high and low level signals representing the second data through the voltage output terminal, or can receive the first data through the voltage output terminal. When the voltage conversion unit 13 outputs the output voltage through the voltage output terminal, the first communication unit 12 stops communicating with the wireless earphone through the voltage output terminal. It can be understood by those skilled in the art that the control unit 14 and the first communication unit 12 can control the communication process based on predetermined communication rules and time sequences, and then complete sending, receiving and parsing of the information. This communication process can be implemented by using the prior art, which is not specifically limited in the present application.

In one embodiment, the voltage conversion unit 13 can also be configured for sending the second data through the voltage output terminal. The voltage conversion unit 13 can adjust the value of its output voltage according to the second data, so as to output high and low level signal representing the second data. At this time, the charging case circuit sends the signal to the wireless earphone circuit while charging the wireless earphone circuit. The control unit determines the reference voltage of the voltage conversion unit 13 according to the second data, so that the reference voltage is adjusted according to the second data, and the voltage conversion unit 13 outputs the output voltage representing the second data through the voltage output terminal.

In one embodiment, the charging case circuit further comprises a first analog-to-digital converter ADC1. The first analog-to-digital converter ADC1 is used to detect the voltage of the first battery BAT1, convert it into a digital signal, and output it to the control unit 14.

The control unit 14 is further configured to obtain the voltage required by the wireless earphone circuit according to the first information from the first communication unit 12. For example, when the first information is the voltage of the battery to be charged, the control unit 14 increases the voltage of the battery to be charged by the predetermined voltage value, so as to obtain the voltage required by the wireless earphone circuit. The predetermined voltage value can be the voltage difference between the input terminal and the output terminal of the charging management unit of the wireless earphone circuit as described above. When the first information is the voltage required by the wireless earphone circuit, the control unit 14 can obtain the voltage required by the wireless earphone circuit from the first information directly.

The control unit 14 may also be configured to determine the reference voltage of the voltage conversion unit 13 for regulation according to the voltage required by the wireless earphone circuit and/or the second data. For example, the voltage required by the wireless earphone circuit is regarded as the reference voltage directly. For another embodiment, the voltage required by the wireless earphone circuit is adjusted according to the second data, and the adjusted voltage required by the wireless earphone circuit is used as the reference voltage. The control unit 14 can configure the reference voltage into the voltage conversion unit 13 through a control instruction, so that the output voltage outputted by the voltage conversion unit 13 is positively related to the voltage of the battery to be charged.

The voltage conversion unit 13 may also have one or more of a buck mode, a boost mode, and a buck-boost mode. A working mode of the voltage conversion unit 13 is determined according to relationship between the voltage required by the wireless earphone circuit and the voltage of the first battery BAT1. The working mode is one of the buck mode, the boost mode, and the buck-boost mode. The voltage conversion unit 13 outputs the output voltage less than the voltage of the first battery BAT1 in the buck mode, outputs the output voltage greater than the voltage of the first battery BAT1 in the boost mode, and output the output voltage greater than or less than the voltage of the first battery BAT1 in the buck-boost mode. Specifically, when the voltage required by the wireless earphone circuit is greater than the voltage of the first battery BAT1, the output voltage of the voltage conversion unit 13 is greater than the voltage of the first battery BAT1. When the voltage required by the wireless earphone circuit is less than the voltage of the first battery BAT1, the output voltage of the voltage conversion unit 13 is lower than the voltage of the first battery BAT1.

For example, the voltage conversion unit 13 only has a buck-boost, the voltage required by the wireless earphone circuit is regarded as the reference voltage, the voltage conversion unit 13 compares the reference voltage with the voltage of the first battery BAT1, and adaptively switches between boost and buck, thereby outputting the output voltage greater or less than the voltage of the first battery BAT1.

The control unit 14 can also be used to control the voltage conversion unit 13 to select the work mode according to the relationship between the voltage required by the wireless earphone circuit and the voltage of the first battery BAT1. In one embodiment, the voltage conversion unit 13 has a buck mode, a boost mode and a buck-boost mode. The voltage conversion unit 13 works in the buck-boost mode when a difference between the voltage of the first battery and the voltage required by the wireless earphone circuit is within a set range. The voltage conversion unit 13 works in the buck mode when the voltage of the first battery is greater than the voltage required by the wireless earphone circuit, and the difference between the voltage of the first battery BAT1 and the voltage required by the wireless earphone circuit exceeds the set range. The voltage conversion unit 13 works in the boost mode when the voltage of the first battery is less than the voltage required by the wireless earphone circuit and the difference between the voltage of the first battery and the voltage required by the wireless earphone circuit exceeds the set range.

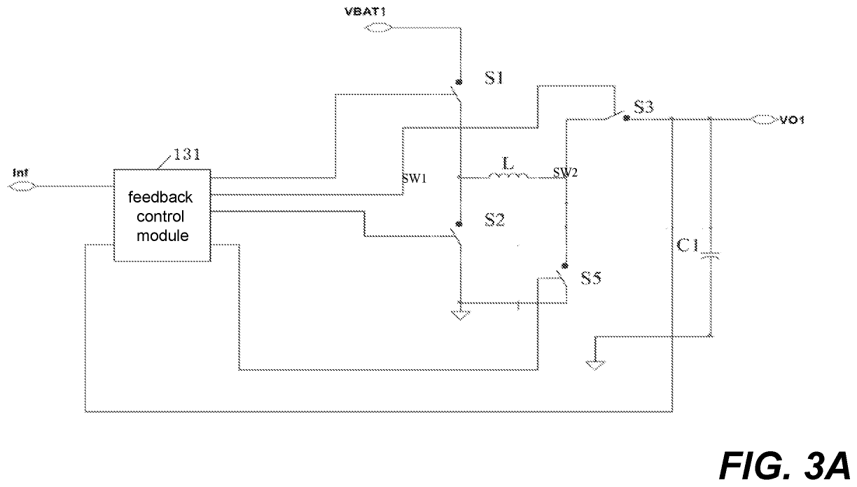

FIG. 3A is a schematic circuit diagram of the voltage conversion unit of the charging case circuit shown in FIG. 2 according to one embodiment of the present invention. As shown in FIG. 3A, the voltage conversion unit 13 comprises a feedback control module 131, an inductor L, an output capacitor and a plurality of switches. The inductor L is used to store and carry energy to generate the output voltage at the voltage output terminal. The feedback control module 131 causes the voltage conversion unit 13 to generate the output voltage for one or more voltage output terminals based on the inductor L by turning on or off the switches. In one embodiment, the feedback control module 131 makes the voltage conversion unit 13 work in the buck-boost mode, the buck mode or the boost mode by turning on or off the switches. In another embodiment, the feedback control module 131 makes the voltage conversion unit 13 work in the buck-boost mode, the buck mode or the boost mode for each voltage output terminal respectively by turning on or off the switches.

In one embodiment, as shown in FIG. 3A, the voltage output terminal comprises a first voltage output terminal VO1, the output capacitor comprises a first output capacitor C1, the voltage conversion unit 13 outputs the output voltage through the first voltage output terminal VO1, and the switches comprise a first switch S1, a second switch S2, a third switch S3 and a fifth switch S5. The first switch S1 is coupled between the output terminal of the first battery BAT1 and a first node SW1. The second switch S2 is coupled to between the first node SW1 and the ground terminal. The third switch S3 is coupled between the first voltage output terminal VO1 and a second node SW2. The fifth switch S5 is coupled between the second node SW2 and the ground terminal. The inductor L is coupled between the first node SW1 and the second node SW2. The first output capacitor C1 is coupled between the first voltage output terminal VO1 and the ground terminal. The feedback control module 131 is configured to turn on or off each of the switches.

Depending on specific implementation, the feedback control module 131 can be implemented by various existing circuit units including timing circuits, comparators, logic control circuits, etc. The feedback control module 131 can receive control instructions from the control unit, such as mode control instructions, and the reference voltage. The feedback control module 131 can also sample the output voltage of the voltage output terminal, so as to turn on or off each switch, switch the working mode of the voltage conversion unit, control the duty cycle of the switch, and control an energy storage period and an energy release period of the inductor L, thereby realizing precise control of the output voltage.

When the first communication unit communicates with the wireless earphone circuit through the first voltage output terminal VO1, the feedback control module 131 turns off the third switch S3.

When the voltage conversion unit 13 is in the buck mode, the first switch S1 and the second switch S2 are turned on alternately, the fifth switch S5 is turned off normally, and the third switch S3 is turned on normally. At this time, the feedback control circuit adjusts the duty cycle of the first switch S1 and the second switch S2 according to the sampled output voltage of the first voltage output terminal VO1 and the reference voltage, so that the output voltage of the first voltage output terminal VO1 is stabilized at a target voltage relative to the reference voltage. When the voltage conversion unit 13 is in the boost mode, the first switch S1 is normally turned on, the second switch S2 is normally turned off, and the third switch S3 and the fifth switch S5 are turned on alternately. At this time, the feedback control circuit adjusts the duty cycle of the third switch S3 and the fifth switch S5 according to the sampled output voltage of the first voltage output terminal VO1 and the reference voltage, so that the output voltage of the first voltage output terminal VO1 is stabilized at the target voltage relative to the reference voltage. When the voltage conversion unit 13 is in the buck-boost mode, the first switch S1 and the second switch S2 are turned on alternately, the fifth switch S5 and the first switch S1 are turned on at the same time, and the third switch S3 and the second switch S2 are turned on at the same time. At this time, the feedback control circuit adjusts the duty cycle of the first switch S1, the second switch S2 and the third switch S3 according to the sampled output voltage of the first voltage output terminal VO1 and the reference voltage, so that the output voltage of the first voltage output terminal VO1 is stabilized at the target voltage related to the reference voltage.

FIG. 3B is a schematic circuit diagram of the voltage conversion unit of the charging case circuit shown in FIG. 2 according to another embodiment of the present invention. As shown in FIG. 3B, the voltage output terminal comprises a first voltage output terminal VO1 and a second voltage output terminal VO2, The voltage conversion unit 13 is a two-output buck-boost circuit. The output capacitors comprise a first output capacitor C1 and a second output capacitor C2. The switches comprise a first switch S1, a second switch S2, a third switch S3, a fourth switch S4 and a fifth switch S5. The first switch S1 is coupled between the output terminal of the first battery BAT1 and the first node SW1. The second switch S2 is coupled to the first between the node SW1 and the ground terminal. The third switch S3 is coupled between the first voltage output terminal VO1 and the second node SW2. The fourth switch S4 is coupled between the second node SW2 and the second voltage output terminal VO2. The fifth switch S5 is coupled between the second node SW2 and the ground terminal. The inductor L is coupled between the first node SW1 and the second node SW2. The first output capacitor C1 is coupled between the first voltage output terminal VO1 and the ground terminal. The second output capacitor C2 is coupled between the second voltage output terminal VO2 and the ground terminal. The feedback control module 131 is configured to turn on or off each switch.

When the third switch S3 is turned off, the voltage conversion unit 13 stops outputting voltage to the first voltage output terminal VO1, and the first communication unit 12 can communicate with the wireless earphone through the first voltage output terminal VO1. When the fourth switch S4 is turned off, the voltage conversion unit 13 stops outputting voltage to the second voltage output terminal VO2, and the first communication unit 12 can communicate with the wireless earphone through the second voltage output terminal VO2.

In FIG. 3B, an operation of the first voltage output terminal VO1 in the buck mode, the boost mode and the buck-boost mode can be referred to the description of FIG. 3A. The following describes the operation of the second voltage output terminal VO2 in the three modes. At this time, only the second earphone may be put into the charging case, and the first earphone may not be put into the charging case. Specifically, when the second voltage output terminal VO2 is in the buck mode, the first switch S1 and the second switch S2 are turned on alternately, the fifth switch S5 is normally turned off, the fourth switch S4 is normally turned on, and the third switch S3 is normally turned off. When the second voltage output terminal VO2 is in the boost mode, the first switch S1 is normally open, the second switch S2 is normally close, the fourth switch S4 and the fifth switch S5 are turned on alternately, and the third switch S3 is normally turned off. When the second voltage output terminal VO2 is in the buck-boost mode, the first switch S1 and the second switch S2 are turned on alternately, the fifth switch S5 and the first switch S1 are turned on at the same time, and the fourth switch S4 and the second switch S2 are turned on at the same time, and the third switch S3 is normally turned off.

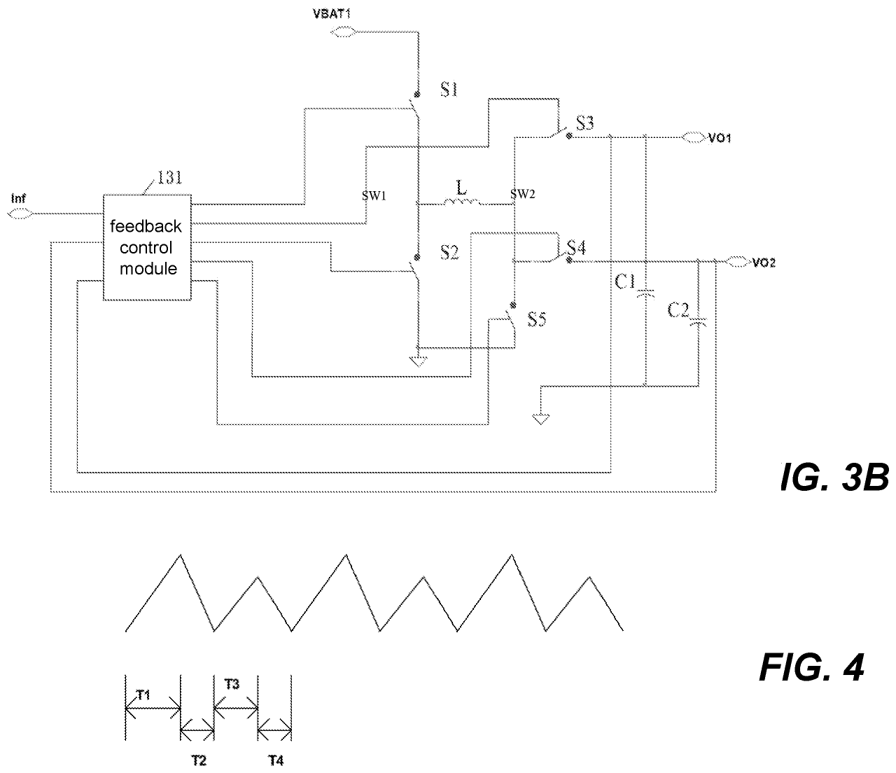

FIG. 4 is a waveform diagram of a current of an inductor in the voltage conversion unit shown in FIG. 3B. As shown in FIG. 4, four periods T1, T2, T3 and T4 are comprised. It should be noted that the waveform of the current of the inductor L in FIG. 4 is an example. In the actual design, the peak value of the current of the inductor in the period T1˜T2 can be higher than or lower than or equal to the peak value of the current of the inductor in the period T3˜T4, and time length of the periods T1, T2, T3, and T4 can also be changed according to the specific design.

The working process of the two-output buck-boost circuit will be described below with reference to FIG. 3B and FIG. 4.

In some cases, the first voltage output terminal VO1 and the second voltage output terminal VO2 are in the buck mode. At this time, the fifth switch S5 is normally turned off. During the first period T1, the first switch S1 and the third switch S3 are turned on. During the second period T2, the second switch S2 and the third switch S3 are turned on. During the third period T3, the first switch S1 and the fourth switch S4 are turned on. During the fourth period T4, the second switch S2 and the fourth switch S4 are turned on.

In some cases, the first voltage output terminal VO1 and the second voltage output terminal VO2 are both in the boost mode. At this time, the first switch S1 is normally turned on, and the second switch S2 is normally turned off. During the first period T1, the fifth switch S5 is turned on. During the second period T2, the third switch S3 is turned on. During the third period T3, the fifth switch S5 is turned on. During the fourth period T4, the fourth switch S4 is turned on.

In some cases, the first voltage output terminal VO1 is in the buck mode, and the second voltage output terminal VO2 is in the boost mode. At this time, during the first period T1, the first switch S1 and the third switch S3 are turned on. During the second period T2, the second switch S2 and the third switch S3 are turned on. During the third period T3, the first switch S1 and the fifth switch S5 are turned on. During the fourth period T4, the first switch S1 and the fourth switch S4 are turned on.

In some cases, the first voltage output terminal VO1 is in the boost mode, and the second voltage output terminal VO2 is in the buck mode. At this time, during the first period T1, the first switch S1 and the fifth switch S5 are turned on. During the second period T2, the switch S1 and the third switch S3 are turned on. During the third period T3, the first switch S1 and the fourth switch S4 are turned on. During the fourth period T4, the second switch S2 and the fourth switch S4 are turned on.

In some cases, both the first voltage output terminal VO1 and the second voltage output terminal VO2 are in the buck-boost mode. At this time, during the first period T1, the first switch S1 and the fifth switch S5 are turned on. During the second period T2, the switch S2 and the third switch S3 are turned on. During the third period T3, the first switch S1 and the fifth switch S4 are turned on. During the fourth period T4, the second switch S2 and the fourth switch S4 are turned on.

In some cases, the first voltage output terminal VO1 is in the buck-boost mode, and the second voltage output terminal VO2 is in the buck mode. At this time, during the first period T1, the first switch S1 and the fifth switch S5 are turned on. During the second period T2, the second switch S2 and the third switch S3 are turned on. During the third period T3, the first switch S1 and the fourth switch S4 are turned on. During the fourth period T4, the second switch S2 and the fourth switch S4 are turned on.

In some cases, the first voltage output terminal VO1 is in the buck-boost mode, and the second voltage output terminal VO2 is in the boost mode. At this time, during the first period T1, the first switch S1 and the fifth switch S5 are turned on. During the second period T2, the second switch S2 and the third switch S3 are turned on. During the third period T3, the first switch S1 and the fifth switch S5 are turned on. During the fourth period T4, the first switch S1 and the fourth switch S4 are turned on.

In some cases, the first voltage output terminal VO1 is in the buck mode, and the second voltage output terminal VO2 is in the buck-boost mode. At this time, during the first period T1, the first switch S1 and the third switch S3 are turned on. During the second period T2, the second switch S2 and the third switch S3 are turned on. During the third period T3, the first switch S1 and the fifth switch S5 are turned on. During the fourth period T4, the second switch S2 and the fourth switch S4 are turned on.

In some cases, the first voltage output terminal VO1 is in the boost mode, and the second voltage output terminal VO2 is in the buck-boost mode. During the first period T1, the first switch S1 and the fifth switch S5 are turned on. During the second period T2, the first switch S1 and the third switch S3 are turned on. During the third period T3, the first switch S1 and the fifth switch S5 are turned on. During the fourth period T4, the second switch S2 and the fourth switch S4 are turned on.

It should be noted that in each period of the four periods T1, T2, T3 and T4, each of the switches not mentioned above is turned off.

In addition, a charging case is provided according to one embodiment of the present application. The charging case comprises the charging case circuit above-mentioned.

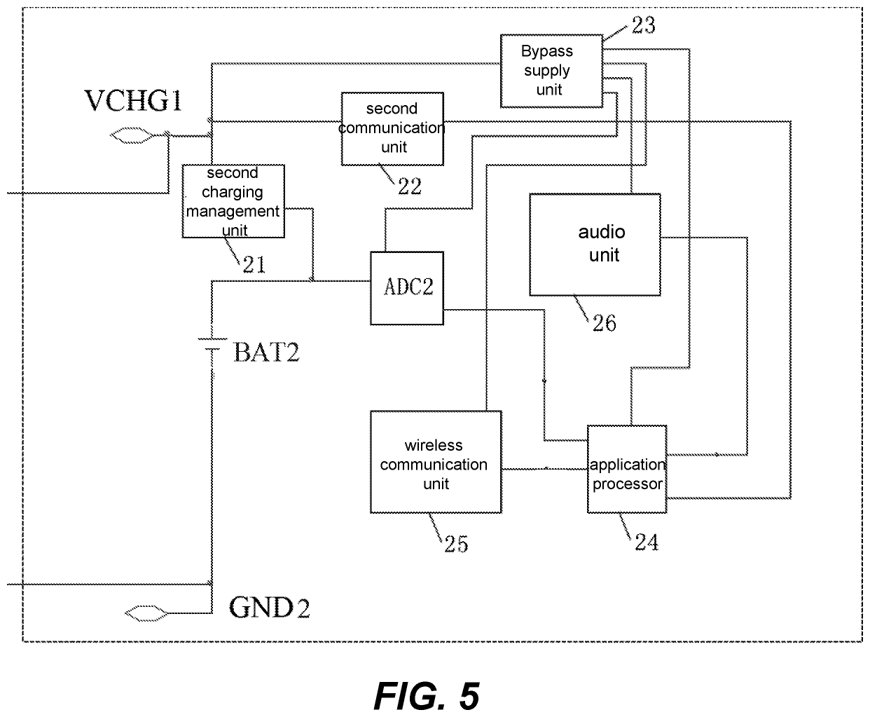

FIG. 5 is a schematic structural diagram of a wireless earphone circuit according to one embodiment of the present application. As shown in FIG. 5, the wireless earphone circuit comprises a second battery BAT2, a second charging management unit 21, a second analog-to-digital converter ADC2 and a second communication unit 22. The second charge management unit 21 is configured for performing charging management to the second battery BAT2, and has a voltage input terminal VCHG for coupling with the voltage output terminal of the charging case circuit. The second analog-to-digital converter ADC2 is used to obtain the voltage of the second battery BAT2 and convert it into a digital signal. The second communication unit 22 is used to send the first data to the charging case circuit. The first data comprises the first information. The first information represents the voltage of the second battery BAT2, so that the charging case circuit adjusts the output voltage thereof according to the first information sent by the second communication unit 22. The first data further comprises at least one of a software program to be loaded into the charging case and a temperature of the second battery BAT2. The software program is an upgrade program for the charging case.

In addition, the wireless earphone circuit further comprises an application processor 24. The application processor 24 receives the second data sent by the charging case circuit through the second communication unit 22. The second data comprises at least one of a state of a cover of the charging case, a temperature and a remaining power of the first battery, and a software program to be loaded into the wireless earphone circuit. The wireless earphone circuit also comprises a wireless communication unit 25. The wireless communication unit 25 sends part of the data in the application processor 24 to the terminal device, such as the mobile phone. The wireless earphone circuit also comprises an audio unit 26 and various memories such as memory and flash memory. The audio unit 26 is used to play information received by the application processor AP and stored in the memories. Further, the wireless earphone circuit further comprises a bypass supply unit 23. The bypass power supply unit 23 is used to provide power to the units in the wireless earphone circuit by using the voltage at the voltage input terminal VCHG1 when the power of the second battery BAT2 is insufficient and the voltage input terminal VCHG1 is coupled to the voltage output terminal. For example, when the second battery BAT2 is empty, the bypass supply unit 23 can provide power to the above-mentioned second charging management unit 21, the second analog-to-digital converter ADC2, the second communication unit 22, the application processor 24, the wireless communication unit 25 and the audio unit 26, so that the wireless earphone can still work when the second battery BAT2 has not enough power. As a result, the wireless earphone can still receive data sent by the charging case circuit through the second communication unit 22, and transmit the data to the terminal device such as a mobile phone through the wireless communication unit 25 for display or processing.

In addition, a wireless earphone is provided according to one embodiment of the present application. The wireless earphone comprises the above-mentioned wireless earphone circuit. Further, a wireless earphone system is provided according to one embodiment of the present application. The wireless earphone system comprises the above-mentioned charging case and the above-mentioned wireless earphone.

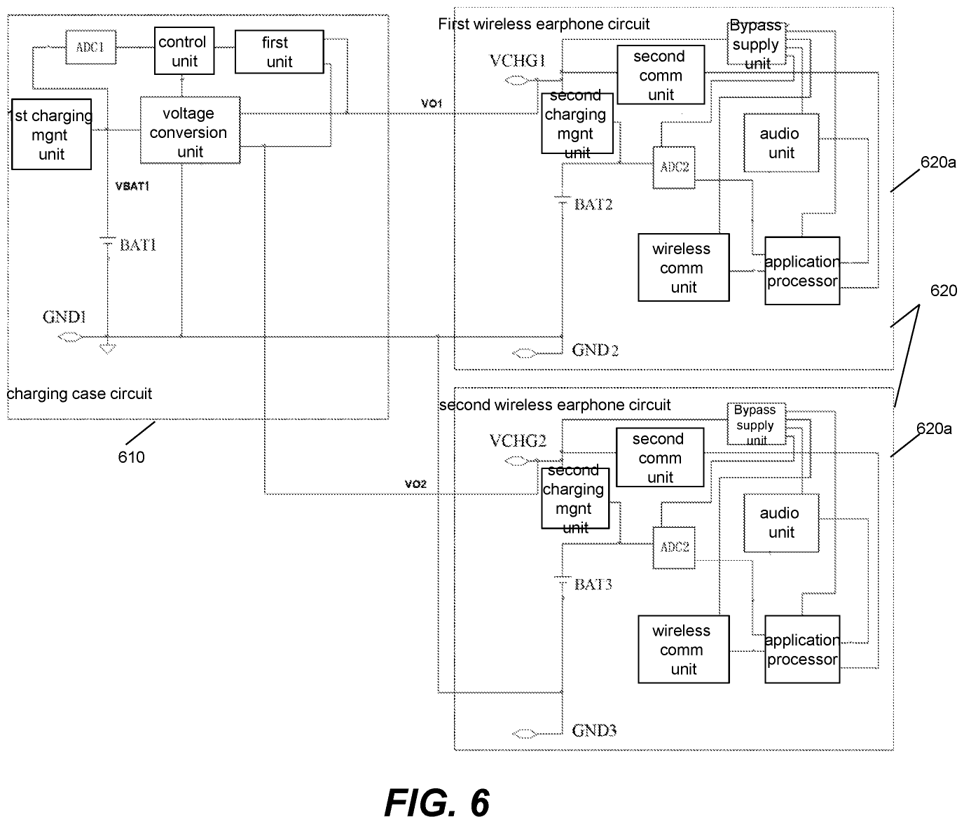

FIG. 6 is a schematic structural diagram of a charging system according to one embodiment of the present application. As shown in FIG. 6, the charging system comprises the above-mentioned charging case circuit 610 and the above-mentioned wireless earphone circuit 620. In FIG. 6, the charging case circuit comprises a two-output buck-boost circuit, and the charging system comprises two wireless earphone circuits, namely a first wireless earphone circuit 620a and a second wireless earphone circuit 620a. The first wireless earphone circuit is located in the first earphone. The second wireless earphone circuit is located in the second earphone. The first wireless earphone circuit 620a is coupled with the first voltage output terminal VO1 of the two-output buck-boost circuit, and the second wireless earphone circuit 620b can be coupled with the second voltage output terminal VO2 of the two-output buck-boost circuit. The two wireless earphone circuits may be the same or different in structure. In the following, two wireless earphone circuits with the same structure are used as an example for introduction.

As mentioned above, the first wireless earphone circuit is taken as an example to introduce. The first wireless earphone circuit may comprise a second battery BAT2, a second charging management unit, a second analog-to-digital converter ADC2, a second communication unit, and a bypass supply unit, an application processor, a wireless communication units and an audio unit. The second charging management unit takes the voltage of the first voltage output terminal VO1 as the input to charge the second battery BAT2. The second communication unit can receive the information sent from the charging case through the first voltage output terminal VO1, and then transmit it to the application processor for processing. The application processor can also send the information to other devices such as the mobile phones through the wireless communication unit. The second analog-to-digital converter ADC2 collects the voltage information of the second battery BAT2 and transmits it to the application processor, and the application processor can transmit the voltage information of the second battery BAT2 to the charging case through the second communication unit. The bypass supply unit can supply power to the second analog-to-digital converter ADC2, the second communication unit, the application processor, the wireless communication unit and the audio unit in the wireless earphone based on the voltage of VCHG1. In this way, when the voltage of the second battery BAT2 of the wireless earphone is particularly low, as long as the first battery BAT1 in the charging case has enough power, the units in the wireless earphone circuit 620a can be powered through VO1, so that the wireless earphone can still work and transmit information to terminal devices such as the mobile phone for information processing and display even if the second battery BAT2 of wireless earphone circuit 620a has no enough power.

The charging case circuit comprises a first battery BAT1, a first charging management unit, a first communication unit, a voltage conversion unit, a control unit and an analog-to-digital converter ADC1. The first charging management unit may receive a voltage (eg, 5V) from an adapter to charge the first battery BAT1. The control unit is composed of MCU or application processor AP. The analog-to-digital converter ADC1 detects the voltage of the first battery BAT1. The control unit receives signals from the first communication unit, and also sends information to the first communication unit. The first communication unit receives information from the first earphone through the first voltage output terminal VO1, and also sends information to the first earphone through the first voltage output terminal VO1. Similarly, the first communication unit receives information from the second earphone through the second voltage output terminal VO2, and also sends information to the second earphone through the second voltage output terminal VO2. The voltage conversion unit takes the voltage of the first battery BAT1 as an input, and generates two output voltages for VO1 and VO2. The voltage conversion unit provides energy to the first earphone through VO1, and the second charging management unit in the first wireless earphone circuit uses the voltage of VO1 as an input to charge the battery BAT2. The voltage conversion unit provides energy to the second earphone through VO2, and the second charging management unit in the second wireless earphone circuit uses the voltage of VO2 as an input to charge the battery BAT3.

The first communication unit of the charging case circuit obtains the voltage of the second earphone battery BAT2 by communicating with the first wireless earphone circuit. The first communication unit obtains the voltage of the third earphone battery BAT3 by communicating with the second wireless earphone circuit. The first communication unit sends the voltage of the second earphone battery BAT2 and the voltage of the third earphone battery BAT3 to the control unit. The control unit also obtains the voltage of BAT1 through ADC1. The voltages of the batteries BAT1, BAT2, and BAT3 will change with the change of their remaining power. When the battery is charged, its voltage gradually rises. When the battery is discharged, its voltage gradually decreases. The control unit adaptively sets the output voltage of the voltage conversion unit according to the voltage of the battery in the wireless earphone. Specifically, the control unit adaptively sets the target value of the first output voltage according to the voltage of the battery BAT2 in the first wireless earphone circuit, and configures the target value as the reference voltage of the feedback control module. Generally, VTarget1=VBAT2+Vmin is set, wherein VTarget1 is the target value of the output voltage of the first voltage output terminal VO1, VBAT2 is the voltage of the earphone battery BAT2, and Vmin is a predetermined voltage value consumed by the second charging management unit of the first wireless earphone circuit, for example, Vmin may be 0.1V. Similarly, the control unit adaptively sets the second output voltage of the voltage conversion unit according to the voltage of the battery BAT3 in the second wireless earphone circuit. Generally, VTarget2=VBAT3+Vmin is set, wherein VTarget2 is the target value of the output voltage of the second voltage output terminal VO2, VBAT3 is the voltage of the battery BAT3, and Vmin is a predetermined voltage value consumed by the second charging management unit of the second wireless earphone circuit.

In the first implementation, the two-output buck-boost circuit adaptively works in the buck-boost mode, and the control unit does not control the working mode of the two-output buck-boost circuit. Taking the first wireless earphone circuit as an example, when the voltage required by the first wireless earphone circuit is greater than the battery BAT1, the output voltage output by the first voltage output terminal VO1 is greater than the voltage of the battery BAT1 in the charging case. When the voltage required by the first wireless earphone circuit is lower than the battery BAT1, the output voltage output by the first voltage output terminal VO1 is lower than the voltage of the battery BAT1 in the charging case. Similarly, the same control way is also adopted for the second voltage output terminal VO2.

In the second implementation, the working mode of the two-output buck-boost circuit is controlled by the control unit. Taking the first wireless earphone circuit as an example, when the control unit determines that the voltage of BAT1 is more greater than the voltage of VTarget1, for example, the voltage of BAT1 is 0.2V greater than VTarget1, the control unit controls the two-output buck-boost circuit to work in the buck mode for the first voltage output terminal VO1. When the control unit determines that the voltage of BAT1 is much lower than that of VTarget1, for example, the voltage of BAT1 is 0.2V lower than VTarget1, the control unit controls the two-output buck-boost circuit to work in the boost mode for the first voltage output terminal VO1. When the control unit determines that the voltage of BAT1 is close to the voltage of VTarget1, for example, the voltage of BAT1 is between VTarget1−0.2V and VTarget1+0.2V, the control unit controls the two-output buck-boost circuit to work in the buck-boost mode for the first voltage output terminal VO1. Similarly, the same control way is also adopted for the second voltage output terminal VO2.

Referring to FIG. 3A and FIG. 3B, the inductor L stores energy, carries energy, generates the voltage VO1 or generates the voltages VO1 and VO2. The command Inf sent by the control unit may include commands representing different working modes. The feedback control module 131 controls the switches S1-S5 according to the instructions, so that the output path for the first voltage output terminal VO1 and the output path for the second voltage output terminal VO2 work in one of the buck mode, the boost mode, and the buck-boost mode respectively.

If only the first earphone is put into the charging case, and the second earphone is not put in the charging case, when the first voltage output terminal VO1 is in the buck mode, S1 and S2 are turned on alternately, S5 is normally turned off, and S3 is normally turned on, S4 is normally turned off. When the first voltage output terminal VO1 is in the boost mode, S1 is normally turned on, S2 is normally turned off, S3 and S5 are turned on alternately, and S4 is turned off normally. When the first voltage output terminal VO1 is in the buck-boost mode, S1 and S2 are turned on alternately, S5 is turned on at the same time when S1 is turned on, S3 is turned on at the same time when S2 is turned on, and S4 is normally turned off.

In the buck-boost mode, S1, S2, S3, and S5 need to constantly switch between the close and open states, which will cause a large switching loss. Specifically, since these switches are made of MOS transistors, their gate voltages are repeatedly charged and discharged, which results in energy loss. In the buck mode, S3 is normally turned on, S5 is normally turned on, and there will be no switching losses in S3 and S5. In the boost mode, S1 is normally turned on, S2 is normally turned on, S4 is normally turned on, there will be no switching losses in S1, S2 and S4, so the buck and boost modes are more energy efficient than the buck-boost modes. Therefore, the second implementation can improve the energy efficiency of the two-output buck-boost circuit compared to the first implementation.

If only the second earphone is put into the charging case, and the first earphone is not put in the charging case, when the second voltage output terminal VO2 is in the buck mode, S1 and S2 are turned on alternately, S5 is normally turned off, and S4 is normally turned on, and S3 is normally turned off. When the second voltage output terminal VO2 is in the boost mode, S1 is normally turned on, S2 is normally turned off, S4 and S5 are turned on alternately, and S3 is normally turned off. When the second voltage output terminal VO2 is in the buck-boost mode, S1 and S2 are alternately turned on, S4 is turned on at the same time when S1 is turned on, S4 is turned on at the same time when S2 is turned on, and S3 is normally turned off.

When both the first earphone and the second earphone are put into the charging case, the first voltage output terminal VO1 and the second voltage output terminal VO2 may be in one of the buck mode, the boost mode and the buck-boost mode, respectively. For details, please refer to the working process of the two-output buck-boost circuit described in FIGS. 3 and 4 above.

In addition, the control unit in the charging case circuit also provides intermittent polling. When polling, a polling command can be sent to the wireless earphone first, and then the voltage conversion unit is controlled to stop supplying power to VO1 and VO2. That is, the switches S3 and S4 are turned off, so that VO1 or VO2 is in a high-impedance state, and the wireless earphone is in a high-impedance state. The first data can be sent to the charging case through the voltage output terminal. For example, the upgrade software of the charging case or the battery voltage information in the wireless earphone can be sent. The polling time interval may be, for example, 1 second.

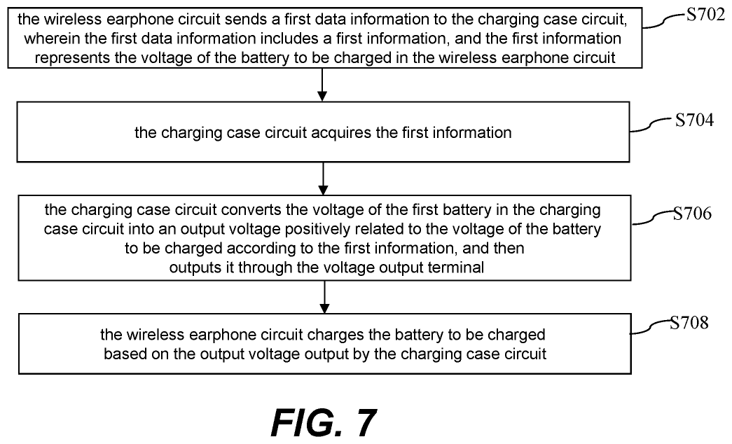

FIG. 7 is a flowchart of a charging method according to one embodiment of the present application. As shown in FIG. 7, the charging method comprises the following operations:

At S702, the wireless earphone circuit sends first data to the charging case circuit, wherein the first data comprises a first information, and the first information represents the voltage of the battery to be charged in the wireless earphone circuit.

At S704, the charging case circuit acquires the first information.

At S706, the charging case circuit converts the voltage of the first battery in the charging case circuit into an output voltage according to the first information, and then outputs it through the voltage output terminal. The output voltage is positively related to the voltage of the battery to be charged, and is greater than or equal to a voltage required by the wireless earphone circuit, and the voltage required by the wireless earphone circuit is a sum of the voltage of the battery to be charged and a predetermined voltage value.

At S708, the wireless earphone circuit charge the battery to be charged based on the output voltage output by the charging case circuit.

To sum up, the first communication unit of the charging case circuit communicates with the wireless earphone to obtain the information representing the voltage of the battery to be charged in the wireless earphone circuit, and the voltage conversion unit converts the voltage of the first battery into the output voltage and output it through the voltage output terminal according to the voltage of the battery to be charged in the wireless earphone circuit obtained by the communication unit. The output voltage is positively related to the voltage of the battery to be charged, and is greater than or equal to a voltage required by the wireless earphone circuit, and the voltage required by the wireless earphone circuit is a sum of the voltage of the battery to be charged and a predetermined voltage value. That is to say, the voltage output by the charging case circuit can change with the voltage required by the wireless earphone circuit in real time, thereby reducing the energy consumption of the charging circuit and improving the energy efficiency.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A charging circuit provided to wirelessly charge an earphone, the charging circuit comprising:
a first battery;
a first charging management unit performing charging management to the first battery;
a first communication unit obtaining data including information representing a voltage of an earphone battery being charged in the earphone via a wireless earphone circuit, wherein the wireless earphone circuit is housed in the earphone; and
a voltage conversion unit converting a voltage of the first battery into an output voltage according to the data and outputting the output voltage through a voltage output terminal, wherein the output voltage is positively related to the voltage of the earphone battery, and is greater than or equal to a voltage required by the wireless earphone circuit, and the output voltage increases in real time as the voltage required by the wireless earphone circuit increases, the output voltage is a sum of the voltage of the earphone battery being charged and a predetermined voltage value.

2. The charging circuit according to claim 1, wherein the first communication unit sends additional data to the wireless earphone circuit; or, the voltage conversion unit sends the second data to the wireless earphone circuit through the voltage output terminal.

3. The charging circuit according to claim 2, wherein the additional data includes at least one of a state of a cover of a charging case, a temperature and a remaining power of the first battery, and a software program to be loaded into the wireless earphone circuit;
the first data further includes at least one of a software program to be loaded into the charging case circuit and a temperature of the battery being charged;
the information further includes the voltage of the battery being charged, or the voltage required by the wireless earphone circuit, or the voltage of the battery being charged and the predetermined voltage value.

4. The charging circuit according to claim 1, further comprising a control unit configured for controlling the first communication unit and the voltage conversion unit to time-division multiplex the voltage output terminal;
when the first communication unit communicates with the wireless earphone circuit through the voltage output terminal, the voltage conversion unit stops outputting the output voltage through the voltage output terminal;
when the voltage conversion unit outputs the output voltage through the voltage output terminal, the first communication unit stops communicating with the wireless earphone circuit through the voltage output terminal.

5. The charging circuit according to claim 2, further comprising a control unit, wherein the control unit is configured for obtaining the voltage required by the wireless earphone circuit according to the first information, and/or, determining a reference voltage of the voltage conversion unit according to the voltage required by the wireless earphone circuit and/or the second data.

6. The charging circuit according to claim 5, wherein the voltage conversion unit has at least one of a buck mode, a boost mode and a buck-boost mode, the voltage conversion unit outputs the output voltage less than the voltage of the first battery in the buck mode, outputs the output voltage greater than the voltage of the first battery in the boost mode, or output the output voltage greater than or less than the voltage of the first battery in the buck-boost mode according to relationship between the voltage required by the wireless earphone circuit and the voltage of the first battery; and/or,
the charging circuit further comprises a first analog-to-digital converter for detecting the voltage of the first battery;
a working mode of the voltage conversion unit is determined according to the relationship between the voltage required by the wireless earphone circuit and the voltage of the first battery.

7. The charging circuit according to claim 6, wherein the voltage conversion unit has the buck mode, the boost mode and the buck-boost mode;
the voltage conversion unit works in the buck-boost mode when a difference between the voltage of the first battery and the voltage required by the wireless earphone circuit is within a set range;
the voltage conversion unit works in the buck mode when the voltage of the first battery is greater than the voltage required by the wireless earphone circuit and the difference between the voltage of the first battery and the voltage required by the wireless earphone circuit exceeds the set range;
the voltage conversion unit works in the boost mode when the voltage of the first battery is less than the voltage required by the wireless earphone circuit and the difference between the voltage of the first battery and the voltage required by the wireless earphone circuit exceeds the set range.

8. The charging circuit according to claim 7, wherein the voltage conversion unit comprises a feedback control module, an inductor, one or more output capacitors and a plurality of switches;
the feedback control module causes the voltage conversion unit to generate the output voltage for one or more voltage output terminals based on the inductor by turning on or off the switches;
the feedback control module makes the voltage conversion unit work in one of the buck-boost mode, the buck mode and the boost mode, or makes the voltage conversion unit work in one of the buck-boost mode, the buck mode and the boost mode for each voltage output terminal respectively by turning on or off the switches.

9. The charging circuit according to claim 8, wherein the voltage output terminal comprises a first voltage output terminal, the output capacitor comprises a first output capacitor, and the voltage conversion unit output the output voltage through the first output terminal, and the switches comprises a first switch, a second switch, a third switch and a fifth switch,
the first switch is coupled between an output terminal of the first battery and a first node SW1, the second switch is coupled between the first node SW1 and a ground terminal, the third switch is coupled between the first voltage output terminal and a second node SW2, the fifth switch is coupled between the second node SW2 and the ground terminal, the inductor is coupled between the first node SW1 and the second node SW2, and the first output capacitor is coupled between the first voltage output terminal and the ground terminal,
the feedback control module is configured to turn on or off each of the switches;
when the first communication unit communicates with the wireless earphone circuit through the first voltage output terminal, the feedback control module turns off the third switch.

10. The charging circuit according to claim 8, wherein the voltage output terminal comprises a first voltage output terminal and a second voltage output terminal, the output capacitor comprises a first output capacitor and a second output capacitor, the switches comprises a first switch, a second switch, a third switch, a fourth switch and a fifth switch,
the first switch is coupled between the output terminal of the first battery and a first node SW1, the second switch is coupled between the first node SW1 and a ground terminal, the third switch is coupled between the first voltage output terminal and the second node SW2, the fourth switch is coupled to between the second node SW2 and the second voltage output terminal, the fifth switch is coupled between the second node SW2 and the ground terminal, the inductor is coupled between the first node SW1 and the second node SW2, the first output capacitor is coupled between the first voltage output terminal and the ground terminal, and the second output capacitor is coupled between the second voltage output terminal and the ground terminal,
the feedback control module is configured to turn on or off each of the switches;
when the first communication unit communicates with the wireless earphone circuit through the first voltage output terminal, the feedback control module turns off the third switch;
when the first communication unit communicates with the wireless earphone circuit through the second voltage output terminal, the feedback control module turns off the fourth switch.

11. A charging circuit in an earphone, the charging circuit comprising:
a battery;
a charging management unit configured for performing charging management to the battery, and comprising a voltage input terminal for coupling with a voltage output terminal of a charging case circuit;
a analog-to-digital converter for obtaining a voltage of the battery; and
a communication unit configured for sending first data to the charging case circuit, the first data comprising a first information representing the voltage of the battery, so that the charging case circuit adjusts an output voltage thereof according to the first information sent by the communication unit.

12. The wireless earphone circuit according to claim 12, wherein the wireless earphone circuit further comprises a bypass supply unit configured for providing power to other modules in the wireless earphone circuit using a voltage at the voltage input terminal when the power of the battery is insufficient and the voltage input terminal is coupled with the voltage output terminal of the charging case circuit; and/or,
the wireless earphone circuit further comprises an application processor for receiving first data sent by the charging case circuit through the communication unit, wherein the data comprises at least one of a state of a cover of a charging case, a temperature and a remaining power of the first battery, and a software program to be loaded into the wireless earphone circuit; and/or,
the wireless earphone circuit further comprises a wireless communication unit configured for performing a wireless communication; and/or,
the first data also comprises at least one of a software program to be loaded into the charging case and a temperature of the battery.

13. A charging method comprising:
obtaining data wirelessly from an earphone when the earphone is in a charging case, the data including information representing a voltage of a battery in the earphone being charged via a wireless earphone circuit housed in the earphone; and
converting a voltage of a battery in the charging case into an output voltage according to the information, and then outputting the output voltage through a voltage output terminal of the charging case, wherein the output voltage increases when the voltage of the battery being charged increases, the output voltage is greater than or equal to a voltage required by the wireless earphone circuit, and the voltage required by the wireless earphone circuit is a sum of the voltage of the battery being charged and a predetermined voltage value.
